(19) United States
(12) Patent Application Publication
(10) Pub. No.: US 2011/0002030 A1
(43) Pub. Date: Jan. 6, 2011

(54) DISPLAY MEDIUM AND ELECTROPHORETIC DISPLAY

(75) Inventor: Chih-Yuan Wang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/829,348

(22) Filed: Jul. 1, 2010

(30) Foreign Application Priority Data
Jul. 2, 2009 (TW) 98122430

(51) Int. Cl. G02F 1/167; C08K 9/10

(52) U.S. Cl. 359/296; 523/205; 523/206

(57) ABSTRACT

An electrophoretic display and a display medium are provided. The electrophoretic display has a plurality of micro-cells and a display medium filled therein. The display medium includes a plurality of particles and a continuous phase solution. Each of the particles has a deformable polymer shell and a filling liquid. The polymer shell has at least an airtight space and the filling liquid is filled in the airtight space. Additionally, the particles are distributed in the continuous phase solution, wherein a density of the particles is substantially equal to a density of the continuous phase solution.

### CROSS-REFERENCE TO RELATED APPLICATION

This application claims the priority benefit of Taiwan application serial no. 98122430, filed on Jul. 2, 2009. The entirety of the above-mentioned patent application is hereby incorporated by reference herein and made a part of specification.

### BACKGROUND OF THE INVENTION

1. Field of the Invention

The invention relates to a display medium and a display, and more particularly to a display medium and a display displaying through electrophoresis.

2. Description of Related Art

Currently commercialized electronic paper displays were developed in the 1990s, and these electronic paper displays have a characteristic of filling colored oil and charged white particles in the capsules. The white particles move upward (closer to a reader) or downward (away from the reader) via the control of the external electric field. The white color shows when the white particles move upward and the color of the oil is displayed when the white particles move downward.

However, in conventional designs, the particles capable of generating electrophoresis are constituted by non-deformable solid particles. Thus, when electrophoresis is generated, the particles collide with each other and cause fractures or losses of electronic powder on the surfaces of the particles. Moreover, the particles generally have greater specific gravity, so the displays must adopt a solution with high viscosity as a material for a continuous phase (that is, the oil aforementioned) to prevent the problem of phase separation between the particles and the solution. The viscosity increase of the solution means the display needs a higher driving voltage for the particles to generate electrophoresis. Therefore, energy consumption required by the electrophoretic display increases, thereby failing to meet the market demand.

### SUMMARY OF THE INVENTION

The invention is directed to a display medium to improve the problem derived from non-deformation and great specific gravity of particles used in an electrophoretic display.

The invention is directed to an electrophoretic display, wherein a driving voltage required is low, and a display medium thereof is not easily damaged so as to have long lifetime and high reliability.

The invention is directed to a display medium including a plurality of particles and a continuous phase solution. Each particle has a deformable polymer shell and a filling liquid. The polymer shell has at least one airtight space, and the filling liquid is filled in the airtight space. Moreover, the particles are distributed in the continuous phase solution. Herein, a density of each particle is approximate to or substantially equal to a density of the continuous phase solution.

The invention is further directed to an electrophoretic display having a plurality of micro-cells and a display medium filled therein. The display medium includes a plurality of particles and a continuous phase solution. Each particle has a deformable polymer shell and a filling liquid. The polymer shell has at least one airtight space and the filling liquid is filled in the airtight space. In addition, the particles are distributed in the continuous phase solution. Here, a density of each particle is substantially equal to a density of the continuous phase solution.

According to an embodiment of the invention, the polymer shell of each particle is transparent. Furthermore, the filling liquid is an emulsifier, for example. The display medium further includes a color material, which is mixed in the filling liquid. Practically, the color material is a black material, a pigment, or a dye. In one embodiment, a number of the airtight spaces is plural and when the color material includes a plurality of dyes or a plurality of pigments, each dye or each pigment is mixed in the filling liquid in one of the airtight spaces respectively.

According to an embodiment of the invention, the polymer shell of each particle of the display medium is white, black, or colored. For example, the display medium further includes a color material doped in the polymer shell. The color material is a black material, a pigment, or a dye. Obviously, the color material also includes a plurality of dyes or a plurality of pigments.

According to an embodiment of the invention, the micro-cells are defined, for example, by a plurality of micro-cups or a plurality of micro-capsules in the electrophoretic display.

In light of the foregoing, in the particle of the display medium according to the invention, the deformable polymer shell encapsulates the filling liquid to constitute at least one liquid inner core. Therefore, when electrophoresis causes the particles to collide or rub against each other, the particles are not damaged easily. By applying the display medium of the invention, the electrophoretic display can have long lifetime and excellent reliability. Moreover, in the display medium of the invention, the density of the particles is adjusted according to the material of the liquid inner core. Hence, the electrophoretic display and the display medium of the invention do not require the use of a continuous phase solution with high viscosity to prevent the phase separation between the particles and the continuous phase solution. Furthermore, a mobility rate of the particles in the continuous phase solution is enhanced effectively, so that a display efficiency of the electrophoretic display is enhanced and the driving voltage of the electrophoretic display is reduced effectively.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an electrophoretic display according to an embodiment of the invention.

FIGS. 2A through 2C illustrate multiple types of particles according to an embodiment of the invention.

FIGS. 3A through 3B illustrate particles each having a surface layer according to an embodiment of the invention.

FIG. 4 illustrates an electrophoretic display according to another embodiment of the invention.

### DESCRIPTION OF EMBODIMENTS

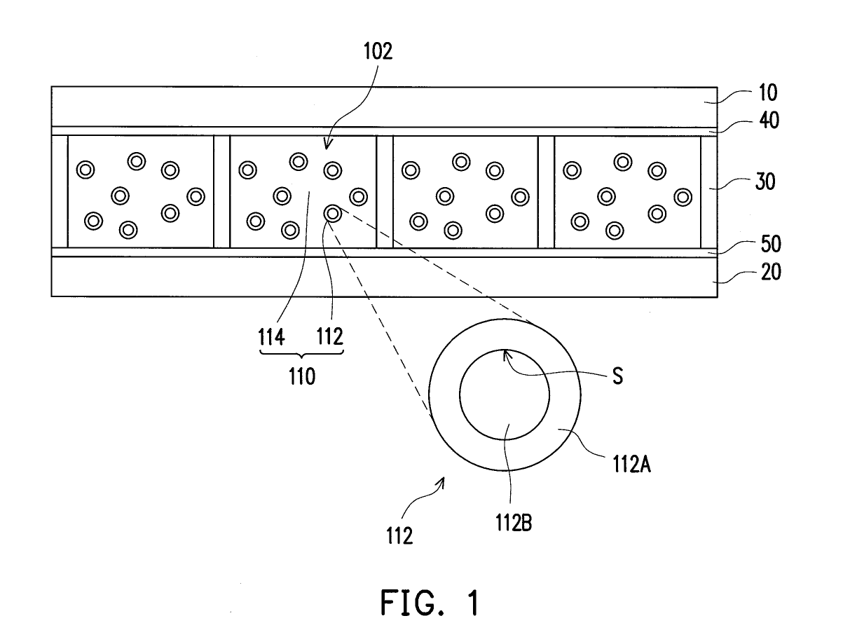

FIG. 1 illustrates an electrophoretic display according to an embodiment of the invention. Referring to FIG. 1, an electrophoretic display 100 has a plurality of micro-cells 102 and a display medium 110 filled in the micro-cells 102. The display medium 110 includes a plurality of particles 112 and a continuous phase solution 114. Each particle 112 has a deformable polymer shell 112A and a filling liquid 112B. The polymer shell 112A has at least one airtight space S and the filling liquid 112B is filled in the airtight space S. Moreover, the particles 112 are distributed in the continuous phase solution 114. Herein, a density of each particle 112 is approximate to or substantially equal to a density of the continuous phase solution 114.

Specifically, the electrophoretic display 100 substantially includes a first substrate 10, a second substrate 20, a spacing structure 30, a first electrode layer 40, and a second electrode layer 50. The first electrode layer 40 is disposed on the first substrate 10, while the second electrode layer 50 is disposed on the second substrate 20. In addition, the spacing structure 30 defines a plurality of micro-cells 102 between the first substrate 10 and the second substrate 20. The display medium 110 is disposed within the micro-cells 102. The electrophoretic display 100 is substantially a display with a micro-cup design. However, the invention is not limited thereto. The electrophoretic display 100 is also designed according to other types.

When the electrophoretic display 100 displays, the first electrode layer 40 and the second electrode layer 50 are, for example, applied with a specific voltage so as to generate a specific electric field in the display medium 110. Under such electric field effect, the particles 112 move in the continuous phase solution 114. When the particles 112 move to a display side, a user can see a color represented by the particles 112. On the contrary, when the particles 112 move away from the display side, the user sees a color of the continuous phase solution 114. Therefore, when the particles 112 and the continuous phase solution 114 represent different colors respectively, the electrophoretic display 100 can display a specific image.

In the present embodiment, the particles 112 are constituted by the polymer shells 112A and the filling liquid 112B, and the polymer shells 112A are a deformable material. Consequently, when the particles 112 move in the continuous phase solution 114, surfaces of the particles 112 are not damaged by collisions with other particles 112. The electrophoretic display 100 therefore has excellent reliability and long lifetime.

Conventional electrophoretic displays mix titanium dioxide particles and oil the display medium, for example. Since the density of titanium dioxide particles and the density of oil are greatly different, titanium dioxide particles sink easily, and thus require a higher driving voltage to float the titanium dioxide particles. In the present embodiment, the density of the particles 112 changes with materials of the polymer shell 112A and the filling liquid 112B. Therefore, the densities of the particles 112 and the continuous phase solution 114 can be substantially the same. When the particles 112 and the continuous phase solution 114 have the same or similar densities, the particles 112 are not easily affected by gravity to sink or float in the continuous phase solution 114. Thus, when displaying, the electrophoretic display 100 does not need to overcome gravity for driving the particles 112 to move to one specific side. In short, a driving electric field required by the electrophoretic display 100 of the present embodiment is small. Therefore, energy consumption is reduced, and demands for energy reduction and power saving are met.

More specifically, the density of the particles 112 is adjustable according to demands of different designs. Therefore, the continuous phase solution 114 does not require a high viscosity property. When a material with low viscosity is selected as the continuous phase solution 114, the particles 112 have a faster mobility rate in the continuous phase solution 114, so the electric field for driving the particles 112 is reduced as a consequence. In addition, the polymer shells 112A of the particles 112 represent an electric double layer property in the electrostatic feature, and outer surfaces thereof represent single charges (that is, carry either positive charges or negative charges). The particles 112 repel each other due to the same electrical charges represented on the surfaces thereof. As a result, when the electrophoretic display 100 displays, an additional interference electric field is not required to separate the particles 112, so that the power consumption required by the electrophoretic display 100 is further reduced. In short, the application of the particles 112 in the electrophoretic display 100 effectively reduces power consumption.

Generally, the first electrode layer 40 and the second electrode layer 50 of the electrophoretic display 100 are manufactured with inorganic materials such as metals, metal oxides, and the like. The polymer shells 112A of the particles 112 are not easily affected by electrostatic adsorption and adhere to the first electrode layer 40 or the second electrode layer 50. This feature further facilitates in reducing the driving voltage of the electrophoretic display 100. Additionally, when a size of the particles 112 is reduced to a certain level, the particles 112 may aggregate together and an optical property thereof alters, especially when the particles 112 have a nanometer scale size, thereby adversely affecting the driving of the particles 112. However, a volume of the electrophoretic display 100 is restricted when the size of the particles 112 is overgreat. Thus, in the present embodiment, a diameter of the particles 112 is, for example, 100 nm˜10,000 nm. Practically, the diameter of the particles 112 is 1,000 nm˜5,000 nm or 1,000 nm˜3,000 nm.

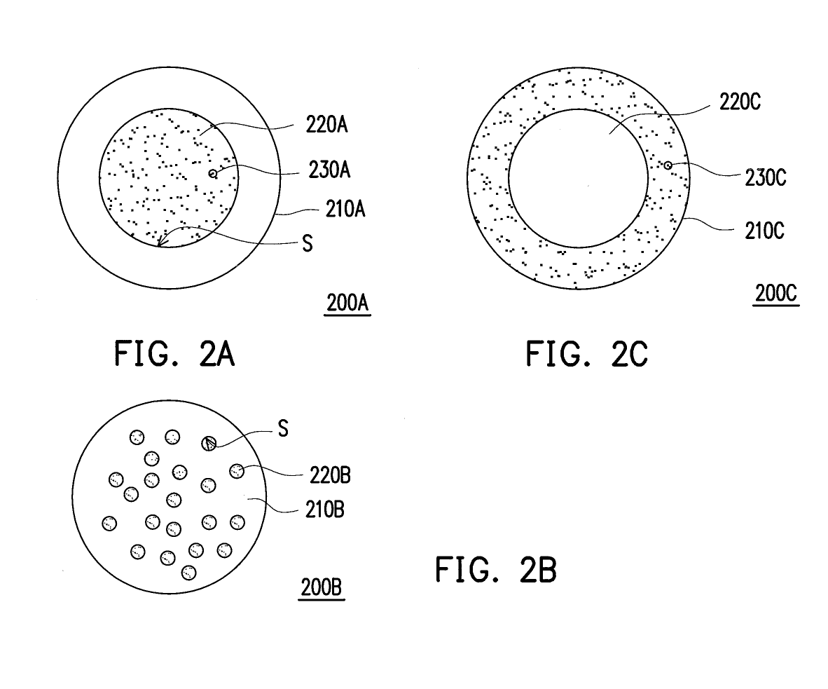

In order for the particles 112 to represent different colors, a design of the particles 112 includes all types of variations as illustrated below. FIGS. 2A through 2C illustrate multiple types of particles according to an embodiment of the invention. Referring to FIG. 2A, a polymer shell 210A of each particle 200A is transparent, for instance. At this time, a color represented by the particle 200A is determined by a filling liquid 220A filled in the airtight space S. For example, the filling liquid 220A can be an emulsifier which represents white, black, or other colors. Certainly, the filling liquid 220A can also be a solid-liquid mixture mixed with micro-particles of white, black, and the like. In practice, a color material 230A such as a black material, a pigment, or a dye is mixed to the filling liquid 220A for representing a specific color. A type or a color of the color material 230A is not limited in the invention, and different color materials 230A are selected according to different product demands. Obviously, in the invention, a plurality of types of color materials 230A can be included in the same particle 200A.

Next, referring to FIG. 2B, in a particle 200B, a number of airtight spaces S included in a polymer shell 210B is plural, and a filling liquid 220B in each airtight space S is mixed with a color material (not shown), for instance. The color material (not shown) is a single-color pigment or dye. Obviously, in other embodiments, the color material (not shown) also includes a plurality of dyes or a plurality of pigments, and each dye or each pigment is mixed in the filling liquid 220B of one of the airtight spaces S respectively. In other words, in the present embodiment, different airtight spaces S are filled with the filling liquids 220B of the same color or the filling liquids 220B of different colors for the particles 200B to represent a particular color.

As shown in FIG. 2A and FIG. 2B, when the polymer shells 210A and 210B of the particles 200A and 200B are transparent, different color materials are doped to the filling liquids 220A and 220B in the present embodiment. The color material is a black material such as pitch and the like, a carbon black, a deep-blue material, a yellow-red-blue mixture material, a light-absorbing material, a single-color pigment or dye, and the like. It should be noted that when the particles 200A or 200B are configured to represent black, not only is the black dye or black material used as the color material, but a plurality of types of dyes or pigments is also mixed to create a black visual effect. To give an example, the filling liquids 220B filled in the airtight spaces S in FIG. 2B are liquids with colors of red, blue, yellow, and the like respectively, so that the particles 200B represent the black color as a whole.

A particle 200C illustrated in FIG. 2C has a non-transparent polymer shell 210C, for example. At this time, a color represented by the particle 200C is determined by the polymer shell 210C. That is, the polymer shell 210C of the particle 200C is white, black, or colored. In order to represent a particular color, a color material 230C is doped into the polymer shell 210C, for instance. The color material 230C includes a black material, a pigment, or a dye. Obviously, the color material 230C also includes a plurality of dyes or a plurality of pigments. In the invention, a type, a form, and the like of the color material 230C is not limited. As long as a material is capable of being doped into the polymer shell 210C to represent a particular color, this material can be selected in the invention. It should be noted that a color of the filling liquid 220C in the particle 200C is not perceived by an observer, thus does not need to be restricted as a particular color.

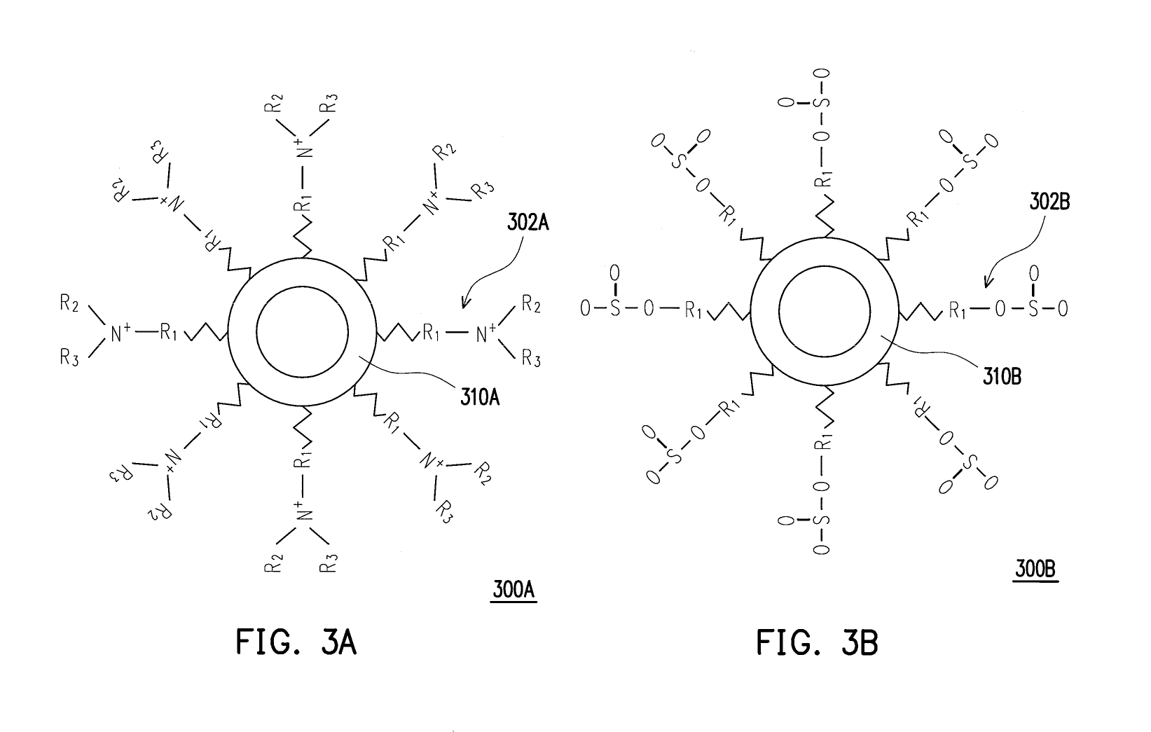

As aforementioned, the electrophoretic display 100 of FIG. 1 applies a low driving voltage to drive, thereby reducing energy consumption and save power. Practically, in order to enhance a response rate of the electrophoretic display 100, a particular surface layer is formed on the surfaces of the particles 112. FIGS. 3A through 3B illustrate particles each having a surface layer according to an embodiment of the invention. Referring to FIG. 3A, a particle 300A further has a surface layer 302A which is coated on a surface of a polymer shell 310A of each particle 300A. In the present embodiment, the surface layer 302A is a positive charge control layer, for example. Here, a material thereof includes an amino-containing polymer, an azo-containing polymer, an aniline series-containing polymer, a nitrogen-containing polymer, or a combination thereof.

In addition, referring to FIG. 3B, a particle 300B has a surface layer 302B which is coated on a surface of a polymer shell 310B of each particle 300B. In the present embodiment, the surface layer 302B is, for instance, a negative charge control layer. A material thereof includes a carbonic acid-containing polymer, a sulfuric acid-containing polymer, a sulfonic acid-containing polymer, a phosphoric acid-containing polymer, a thiol series-containing polymer, a phosphorus-containing polymer, a sulfur-containing polymer, or a combination thereof. Through an effect of the surface layers 302A and 302B, an intensity for sensing the electric field of the particles 300A and 300B is further enhanced. Consequently, the particles 300A and 300B have higher response rates when adopted in the display, so that the display saves more power.

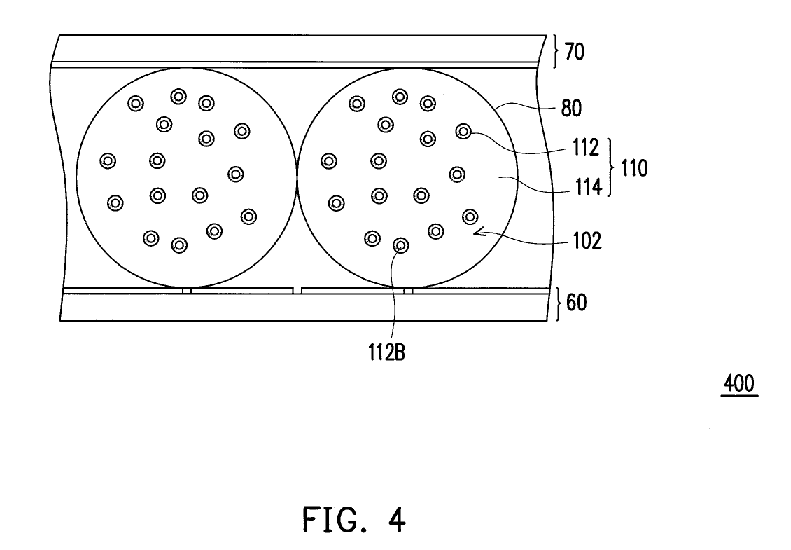

FIG. 4 illustrates an electrophoretic display according to another embodiment of the invention. Referring to FIG. 4, an electrophoretic display 400 includes an array substrate 60, a front substrate 70, and a plurality of micro-capsules 80. The micro-capsules 80 are disposed between the array substrate 60 and the front substrate 70, and define a plurality of micro-cells 102. Furthermore, the micro-cells 102 are filled with the display medium 110. In the present embodiment, the display medium 110 is substantially the display medium 110 applied in the electrophoretic display 100 in FIG. 1. That is, the display medium 110 includes a plurality of particles 112 and a continuous phase solution 114. Each particle 112 has a deformable polymer shell 112A and a filling liquid 112B. The polymer shell 112A has at least one airtight space S, and the filling liquid 112B is filled in the airtight space S. In addition, the particles 112 are distributed in the continuous phase solution 114. Here, the density of each particle 112 is substantially equal to the density of the continuous phase solution 114.

Practically, a difference between the electrophoretic display 400 and the electrophoretic display 100 regards to method of packaging the display medium 110. That is, in one method, the display medium 110 is packaged in the micro-capsule 80 form, and in the other method, the display medium 110 is packaged in a micro-cup form. However, the invention is not limited thereto. The display medium 110 of the invention is also adopted in other displays for display purposes.

In the present embodiment, the particles 112 in the display medium 110 is also any one or multiple type(s) of particles 200A-200C, 300A, and 300B illustrated in FIGS. 2A through 2C and FIGS. 3A-3B. Hence, the electrophoretic display 400 at least has advantages of low driving voltage, high response rate, high reliability, and the like. Moreover, in order for the display medium 110 to have a specific property to satisfy the demand of the product, other additives are added to the filling liquid 112B. For example, salts and the like are added to the filling liquid 112B to change the electrical property of the particles 112 in the electric field.

In summary, in the invention, the particles of the display medium has the design of using the polymer shells to encapsulate the filling liquid for constituting the liquid inner core. Hence, the density of the particles is adjusted along with different demands and further facilitates in reducing the driving voltage required by the electrophoretic display. Furthermore, the display medium of the invention does not require a high viscosity material for the continuous phase solution. Therefore, the mobility rate of the particles in the display medium is fast and the energy required for moving is low. That is, the electrophoretic display of the invention has the features of high response rate and low power consumption. Additionally, the particles of the display medium of the invention have the deformable feature, so that the surfaces of the particles are not easily damaged by direct collision when contacting one another. Therefore, the display medium of the invention facilitates in enhancing the reliability and the lifetime of the electrophoretic display.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display medium, comprising:
a plurality of particles, each of the particles having a deformable polymer shell and a filling liquid, and the polymer shell having at least an airtight space and the filling liquid filled in the airtight space; and
a continuous phase solution, the particles distributed in the continuous phase solution, wherein a density of each of the particles is substantially equal to a density of the continuous phase solution.

2. The display medium as claimed in claim 1, wherein the polymer shell of each of the particles is transparent.

3. The display medium as claimed in claim 2, wherein the filling liquid is an emulsifier.

4. The display medium as claimed in claim 2, further comprising a color material mixed in the filling liquid, and the color material is a black material, a pigment, or a dye.

5. The display medium as claimed in claim 2, further comprising a color material mixed in the filling liquid, wherein each of the particles has multiple airtight spaces and the color material comprises a plurality of dyes or a plurality of pigments, and each of the dyes or each of the pigments is mixed to the filling liquid in one of the airtight spaces respectively.

6. The display medium as claimed in claim 1, wherein the polymer shell of each of the particles is white, black, or colored.

7. The display medium as claimed in claim 6, further comprising a color material, doped in the polymer shell, wherein the color material is a black material, a pigment, or a dye.

8. The display medium as claimed in claim 6, further comprising a color material, doped in the polymer shell, and the color material comprising a plurality of dyes or a plurality of pigments.

9. The display medium as claimed in claim 1, wherein each of the particles further comprises a surface layer coated on a surface of the polymer shell of each of the particles, and the surface layer comprises a positive charge control layer or a negative charge control layer.

10. The display medium as claimed in claim 9, wherein a material of the positive charge control layer comprises an amino-containing polymer, an azo-containing polymer, an aniline series-containing polymer, a nitrogen-containing polymer, or a combination thereof.

11. The display medium as claimed in claim 9, wherein a material of the negative charge control layer comprises a carbonic acid-containing polymer, a sulfuric acid-containing polymer, a sulfonic acid-containing polymer, a phosphoric acid-containing polymer, a thiol series-containing polymer, a phosphorus-containing polymer, a sulfur-containing polymer, or a combination thereof.

12. The display medium as claimed in claim 1, wherein a diameter of the plurality of particles is 100 nm-10,000 nm.

13. An electrophoretic display having a plurality of micro-cells and a display medium filled therein, and the display medium comprising:
a plurality of particles, each of the particles having a deformable polymer shell and a filling liquid, and the polymer shell having at least an airtight space and the filling liquid filled in the airtight space; and
a continuous phase solution, the plurality of particles distributed in the continuous phase solution and a density of each of the particles substantially equaled to a density of the continuous phase solution,
wherein the plurality of micro-cells is defined by a plurality of micro-cups or a plurality of micro-capsules.
